(19) United States
(12) Patent Application Publication
(10) Pub. No.: US 2022/0039383 A1
(43) Pub. Date: Feb. 10, 2022

(54) Use of the Succinate Dehydrogenase Inhibitor Fluopyram for Controlling Claviceps Purpurea and Reducing Sclerotia in Cereals

(71) Applicant: Bayer Aktiengesellschaft, Leverkusen (DE)

(72) Inventors: Kelly Patzer, Foothills (CA); Jocelyn Kratchmer, Saskatoon (CA); David Blatta, Winnipeg (CA)

(21) Appl. No.: 17/276,616

(22) PCT Filed: Sep. 13, 2019
(86) PCT No.: PCT/EP2019/074594

§ 371 Date: Mar. 16, 2021

(30) Foreign Application Priority Data
Sep. 17, 2018 (EP) 18194942.1

(51) Int. Cl. A01N 43/40

(52) U.S. Cl. CPC A01N 43/40

(57) ABSTRACT

The method and use of the succinate dehydrogenase inhibitor Fluopyram, for controlling Claviceps purpurea in cereal plants, plant parts thereof, plant propagation material or the soil in which cereal plants are grown or intended to be grown, includes treating plants or plant parts for controlling Claviceps purpurea. The method can also include controlling Claviceps purpurea in the seed and in the plants which grow from the seed, by treating the seed with the succinate dehydrogenase inhibitor Fluopyram.

### CROSS-REFERENCE TO RELATED APPLICATIONS

This application is the United States national phase of International Application No. PCT/EP2019/074594 filed Sep. 13, 2019, and claims priority to European Patent Application No. 18194942.1 filed Sep. 17, 2018, the disclosures of which are hereby incorporated by reference in their entirety.

### BACKGROUND OF THE INVENTION

### Field of the Invention

The invention relates to the use of the succinate dehydrogenase inhibitor Fluopyram for controlling Claviceps purpurea and reducing sclerotia in cereals, to a method for treating cereal plants, plant parts thereof, for controlling Claviceps purpurea and reducing sclerotia in cereal plants.

### Brief Description of the Related Art

Claviceps purpurea is the fungus causing so called ergot in grasses like rye and ryegrass (principal economic hosts), barley, oats, triticale, spring wheat, durum wheat and other cultivated and wild grass species in the subfamily Pooideae, including bentgrass, bluegrass and fescue. Claviceps purpurea is unique as the fungus only infects ovaries of the host plant. During infection of the host plant the plant ovary is replaced by a blackish sclerotia often called an ergot or ergot body. The sclerotia are the overwintering spore form of the fungus which will partly be harvested with the crop and will partly fall to the ground. The sclerotia will need a vernalization period of about four to eight weeks with temperatures between 0 and 10 degree Celsius in order to break dormancy and germinate. The sclerotium consists of a whitish mycelial tissue containing storage cells and a dark pigmented outer cortex that protects the fungal mycelia from desiccation, UV light and other adverse environmental conditions. Due to its unique infection mode, open pollinated cereal species are highly susceptible to infection, in particular rye and triticale.

The main problem of the disease besides yield reduction is the toxic alkaloids of the sclerotia causing significant health issues both in animals and plants. Poisoning outbreaks are called ergotism and have already been described in the middle ages where consumption of flour ground from rye seed contaminated with ergot bodies led to gangrene, mental hallucinations and convulsions. Claviceps purpurea infection benefits from cooler and more humid weather conditions during the flowering period of the cereal plant. The disease is managed using different techniques like seed cleaning, planting of clean seed, sanitation of field borders and weed control, crop rotation or deep plowing. To determine disease severity, typically the amount of sclerotia/ergot bodies is assessed in the grain, as it is highly difficult to assess the disease in earlier stages of infection. Assessment of the amount of honey dew produced by the fungus during infection is not predictive for the amount of sclerotia present in the grain. Consequently the presence of sclerotia also called ergot or ergot bodies in harvested grain of different types is a grading factor eg in the Official Grain Guiding Guide of Canada (https://www.grainscanada.gc.ca/oggg-gocg/ggg-gcg-eng.htm). Already low levels of ergot will lead to downgrading of grain, in particular in grain of higher quality like registered, certified or breeder grade. In grain which is meant for human and animal consumption like rye or wheat, tolerance levels are much lower than in grain not consumed by humans or animals like it is the case for forage grass. The schedule I to the Seeds Regulation outlines in table XI, XII, and XIII for forage grasses a maximum of 3% ergot bodies in the seed, ie up to 3 ergot bodies per 100 kernels of seed (Foundation/Registered/Certified/Common) is tolerated. For wheat grain meant for food and feed the threshold is much lower with 0.04%. However, fungicides capable of controlling Claviceps purpurea, which would solve the underlying problem in a highly efficient manner, are rare. So far, azoxystrobin or propiconazole are labelled for the use against ergot in the Pacific Northwest, but only for use in sorghum. However for example Germany at least in 2015 no fungicide labelled for Claviceps was available in the market (T. Miedaner and H H Geiger, Toxins (2015), 7, 659-678; doi:10.3390/toxins7030659). Recently a study described the use of eight different fungicidal products (azoxystrobin/propiconazole, boscalid, dicloran, fluazinam, fluopyram/prothioconazole, pentachloronitrobenzene, picoxystrobin/cyproconazole, fluxapyroxad/pyraclostrobin as soil applied fungicides in perennial grasses (Dung et al, Crop Protection 106 (2018), pp 146-149) with the objective to find a more environmental sustainable solution in perennial grasses to eliminate ergot bodies of the soil instead of open field burning. Another study (Kaur: Seed Production Research at Oregon State University, 31 Dec. 2015 (2015 Dec. 31), pages 23-26, XP055513691) evaluated also different fungicides, also the product Propulse comprising Fluopyram and Prothioconazole in grass seed production both in soil and foliar application. The foliar application was only assessed regarding the disease severity, which is not necessarily correlated to the rate of later ergot body formation. Ergot boy formation was only studied in soil application in spring and fall. As those crops are perennials results cannot be directly correlated to efficacy in cereals like rye and wheat which are annual crops. It should also be emphasized that despite these studies do not imply that one of these products is yet available in the market with a label allowing use against Claviceps in cereals. Another problem is encountered if multiple fungicide applications are needed before anthesis/flowering, which is not feasible regarding the economic impact. Other measures to control Claviceps effectively include breeding for resistant cereals varieties which is difficult due to the subtle infection mechanism (T. Miedaner and H H Geiger, Toxins (2015), 7, 659-678; doi:10.3390/toxins7030659). Agronomic measures in addition will only be able to deliver a limited outcome (T. Miedaner and H H Geiger, Toxins (2015), 7, 659-678; doi:10.3390/toxins7030659).

Furthermore, in many areas of annual cereal production, perennial grasses are grown in ditches, roadsides and riparian areas to stabilize high slope soils and thereby prevent soil erosion. Since many species of forage grasses are susceptible to ergot, these areas act as a perennial reservoir of ergot inoculum which then infects cereal crops on an annual basis. Additionally, in harvested grain of classical cereals like rye, barley, spring wheat or durum meant for human or animal consumption, a significantly higher degree of control is required, therefore the level of control as show in Dung is not considered sufficient. Also perennial grasses are different from the cereals used in food production such as wheat and rye which are annual crops. In addition, the soil application of fungicides represents a very different type of application in contrast to for example a foliar application in the flowering stage where the formation of ergot would be controlled before any ergot is formed by controlling the fungus. In particular, in hybrid cereals like hybrid wheat there is a strong need to control Claviceps and prevent ergot body formation as the male sterile plants flower for a longer period of time and are thereby more susceptible (T. Miedaner and H H Geiger, Toxins (2015), 7, 659-678; doi:10.3390/toxins7030659).

There is therefore an urgent need for fungicides which enable sufficient control of Claviceps purpurea in cereal plants in an economically feasible manner.

WO 2004/16088 discloses derivatives of the pyridinylethylbenzamide fungicides, for example Fluopyram (Example 20), which are utilized against different fungi. However, it is not apparent from the teaching of the publication which specific pyridinylethylbenzamide fungicides are suitable for treatment of Claviceps purpurea. Fluopyram is known mainly as a foliar fungicide for fruits and vegetables under the brand-name Luna′ sold by Bayer CropScience. More particularly, all documents do not explicitly disclose the suitability of Fluopyram for control of Claviceps purpurea and/or reduction of sclerotia, in using foliar application.

### SUMMARY OF THE INVENTION

It has now been found that, surprisingly, the succinate dehydrogenase inhibitor Fluopyram is particularly suitable for control of Claviceps purpurea and/or for reduction of sclerotia of Claviceps purpurea in cereal plants, plant parts thereof, plant propagation material or the soil in which cereal plants are grown or intended to be grown. Fluopyram is also suitable to control Claviceps purpurea and is able to reduce sclerotia of Claviceps purpurea in hybrid cereals, in particular hybrid wheat and in hybrid wheat seed production, potentially also a low rate. It has been found that Fluopyram is able to control Claviceps purpurea and for reduction of sclerotia of Claviceps purpurea in cereals, at a low dose rate. It has been found that Fluopyram is able to control Claviceps purpurea using foliar application. The use of Fluopyram for control of Claviceps purpurea and/or for reduction of Claviceps purpurea sclerotia in wheat has been found to be particularly advantageous.

In an alternative embodiment of the invention, combinations comprising Fluopyram and a further fungicide can be used for control of Claviceps purpurea in cereal plants.

The present invention accordingly provides for the use of the succinate dehydrogenase inhibitor Fluopyram for control of Claviceps purpurea and/or for reduction of sclerotia of Claviceps purpurea. In another embodiment the use of the succinate dehydrogenase inhibitor Fluopyram in hybrid wheat production methods for control of Claviceps purpurea and/or for reduction of sclerotia of Claviceps purpurea is described.

Fluopyram, which has the chemical name N-{[3-chloro-5-(trifluoromethyl)-2-pyridinyl]ethyl}-2-trifluoromethylbenzamide and is a compound according to formula (I)

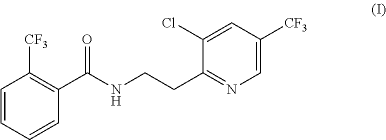 [SMILES: O=C(NCCc1ncc(C(F)(F)F)cc1Cl)c1ccccc1C(F)(F)F]

and suitable processes for preparation thereof, proceeding from commercially available starting materials, are described in WO 2004/16088.

In the context of the present invention, “control of Claviceps purpurea” means a significant reduction in infestation by Claviceps purpurea, compared with the untreated plant, preferably a significant reduction (by 40-79%), compared with the untreated plant (0% infection reduction); more preferably, the infection by Claviceps purpurea is entirely suppressed (by 70-100%). The control may be curative, i.e. for treatment of recently infected plants, or protective, for protection of plants which have not yet been infected.

In the context of the present invention, “reduction of sclerotia of Claviceps purpurea” or “control of Claviceps purpurea” means a significant reduction in the number of sclerotia of Claviceps purpurea, compared with the untreated plant, preferably a significant reduction (by 40-79%), compared with the untreated plant (0% infection reduction); more preferably, the infection by Claviceps purpurea is entirely suppressed (by 70-100%). The amount of sclerotia can be measured either pre-harvest or post harvest in the grain. The control may be curative, i.e. for treatment of recently infected plants, or protective, for protection of plants which have not yet been infected.

In the context of the present invention, a plant is preferably understood to mean a plant at or after the stage of leaf development (at or after BBCH stage 10 according to the BBCH monograph from the German Federal Biological Research Centre for Agriculture and Forestry, 2nd edition, 2001). In the context of the present invention, the term “plant” is also understood to mean seed or seedlings.

Cereals is defined to be cultivated crops of the Poaceae. In particular, cereals are selected from the group of rye, oat, barley, triticale, wheat (spring wheat or winter wheat), durum. More preferred including barley, rye, triticale, spring wheat, hybrid spring wheat, durum, or hybrid winter wheat.

In one embodiment wheat is selected to be winter wheat or spring wheat or durum wheat.

In one embodiment wheat is selected to be hybrid spring wheat, durum, or hybrid winter wheat.

### Uses

The treatment of the plants and plant parts with Fluopyram or compositions comprising Fluopyram is carried out directly or by acting on the environment, habitat or storage space using customary treatment methods, for example by dipping, spraying, atomizing, misting, evaporating, dusting, fogging, scattering, foaming, painting on, spreading, injecting, drenching, trickle irrigation and, in the case of propagation material, in particular in the case of seed, furthermore by the dry seed treatment method, the wet seed treatment method, the slurry treatment method, by encrusting, by coating with one or more coats and the like. It is furthermore possible to apply the active substances by the ultra-low volume method or to inject the active substance preparation or the active substance itself into the soil.

A preferred direct treatment of the plants is the leaf application treatment, i.e. Fluopyram or compositions comprising Fluopyram are applied to the foliage, it being possible for the treatment timing and application rate to be matched to the infection pressure of the Claviceps purpurea in question.

In the case of systemically active compounds, Fluopyram or compositions comprising Fluopyram reach the plants via the root system. In this case, the treatment of the plants is effected by allowing Fluopyram or compositions comprising Fluopyram to act on the environment of the plant. This can be done for example by drenching, incorporating in the soil or into the nutrient solution, i.e. the location of the plant (for example the soil or hydroponic systems) is impregnated with a liquid form of Fluopyram or compositions comprising Fluopyram, or by soil application, i.e. the Fluopyram or compositions comprising Fluopyram are incorporated into the location of the plants in solid form (for example in the form of granules).

More particularly, the inventive use exhibits the advantages described on cereal plants, plant parts thereof, plant propagation material or the soil in which cereal plants are grown or intended to be grown in spray application using compositions comprising Fluopyram.

Combinations of Fluopyram, with substances including insecticides, fungicides and bactericides, fertilizers, growth regulators, can likewise find use in the control of plant diseases in the context of the present invention. The combined use of Fluopyram, with hybrid crops, especially of hybrid wheat, is additionally likewise possible. The use of Fluopyram is effected preferably with a dosage between 0.01 and 3 kg of Fluopyram/ha, more preferably between 0.05 and 2 kg of Fluopyram/ha, more preferably between 0.1 and 1 kg of Fluopyram/ha, and most preferably between 50 and 300 g/ of Fluopyram ha. A dosage of 60 to 250 g of Fluopyram/ha is also disclosed. In another embodiment the dosage is between 60 and 100 g of Fluopyram/ha, mostly preferred 70, 75 or 80 grams of Fluopyram per ha.

### Formulations

In one embodiment, fungicidal compositions comprising Fluopyram are described which further comprise agriculturally suitable auxiliaries, solvents, carriers, surfactants or extenders.

According to the invention, a carrier is a natural or synthetic, organic or inorganic substance with which the active ingredients are mixed or combined for better applicability, in particular for application to plants or plant parts or seed. The carrier, which may be solid or liquid, is generally inert and should be suitable for use in agriculture.

Useful solid carriers include: for example ammonium salts and natural rock flours, such as kaolins, clays, talc, chalk, quartz, attapulgite, montmorillonite or diatomaceous earth, and synthetic rock flours, such as finely divided silica, alumina and silicates; useful solid carriers for granules include: for example, crushed and fractionated natural rocks such as calcite, marble, pumice, sepiolite and dolomite, and also synthetic granules of inorganic and organic flours, and granules of organic material such as paper, sawdust, coconut shells, maize cobs and tobacco stalks; useful emulsifiers and/or foam-formers include: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Additionally suitable are oligo- or polymers, for example those derived from vinylic monomers, from acrylic acid, from EO and/or PO alone or in combination with, for example, (poly)alcohols or (poly)amines. It is also possible to use lignin and its sulphonic acid derivatives, unmodified and modified celluloses, aromatic and/or aliphatic sulphonic acids and also their adducts with formaldehyde.

Fluopyram can be converted to the customary formulations, such as solutions, emulsions, emulsifiable concentrates, wettable powders, water- and oil-based suspensions, powders, dusts, pastes, soluble powders, soluble granules, granules for broadcasting, suspoemulsion concentrates, natural products impregnated with active ingredient, synthetic substances impregnated with active ingredient, fertilizers and also microencapsulations in polymeric substances.

Fluopyram can be applied as such, in the form of its formulations or the use forms prepared therefrom, such as ready-to-use solutions, emulsions, water- or oil-based suspensions, powders, wettable powders, pastes, soluble powders, dusts, soluble granules, granules for broadcasting, suspoemulsion concentrates, natural products impregnated with active ingredient, synthetic substances impregnated with active ingredient, fertilizers and also microencapsulations in polymeric substances. Application is accomplished in a customary manner, for example by watering, spraying, atomizing, broadcasting, dusting, foaming, spreading-on and the like. It is also possible to deploy the active ingredients by the ultra-low volume method or to inject the active ingredient preparation/the active ingredient itself into the soil. It is also possible to treat the seed of the plants.

The formulations mentioned can be prepared in a manner known per se, for example by mixing the active ingredients with at least one customary extender, solvent or diluent, emulsifier, dispersant and/or binder or fixing agent, wetting agent, a water repellent, if appropriate siccatives and UV stabilizers and if appropriate dyes and pigments, antifoams, preservatives, secondary thickeners, stickers, gibberellins and also other processing auxiliaries.

The present invention includes not only formulations which are already ready for use and can be deployed with a suitable apparatus to the plant or the seed, but also commercial concentrates which have to be diluted with water prior to use.

Fluopyram may be present as such or in its (commercial) formulations and in the use forms prepared from these formulations as a mixture with other (known) active ingredients, such as insecticides, attractants, sterilants, bactericides, acaricides, nematicides, fungicides, growth regulators, herbicides, fertilizers, safeners and/or semiochemicals.

The auxiliaries used may be those substances which are suitable for imparting particular properties to the composition itself or and/or to preparations derived therefrom (for example spray liquors, seed dressings), such as certain technical properties and/or also particular biological properties. Typical auxiliaries include: extenders, solvents and carriers.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which may optionally also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

Liquefied gaseous extenders or carriers are understood to mean liquids which are gaseous at standard temperature and under standard pressure, for example aerosol propellants such as halohydrocarbons, or else butane, propane, nitrogen and carbon dioxide.

In the formulations it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

If the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water. Compositions comprising Fluopyram may additionally comprise further components, for example surfactants. Suitable surfactants are emulsifiers and/or foam formers, dispersants or wetting agents having ionic or nonionic properties, or mixtures of these surfactants. Examples thereof are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example alkylaryl polyglycol ethers, alkylsulphonates, alkyl sulphates, arylsulphonates, protein hydrolysates, lignosulphite waste liquors and methylcellulose. The presence of a surfactant is necessary if one of the active ingredients and/or one of the inert carriers is insoluble in water and when application is effected in water. The proportion of surfactants is between 5 and 40 percent by weight of the inventive composition.

Further additives may be perfumes, mineral or vegetable, optionally modified oils, waxes and nutrients (including trace nutrients), such as salts of iron, manganese, boron, copper, cobalt, molybdenum and zinc. Additional components may be stabilizers, such as cold stabilizers, preservatives, antioxidants, light stabilizers, or other agents which improve chemical and/or physical stability.

If appropriate, other additional components may also be present, for example protective colloids, binders, adhesives, thickeners, thixotropic substances, penetrants, stabilizers, sequestering agents, complex formers. In general, the active ingredients can be combined with any solid or liquid additive commonly used for formulation purposes.

The formulations contain generally between 0.05 and 99% by weight, 0.01 and 98% by weight, preferably between 0.1 and 95% by weight, more preferably between 0.5 and 90% of active ingredient, even more preferably between 5 and 80% of active ingredient, and most preferably between 10 and 70 percent by weight. In one embodiment formulations of Fluopyram comprise 100 to 700 g/L Fluopyram as an SC or FS formulation, preferably 150 to 600 g/L Fluopyram as an EC or SC formulation.

The formulations described above may be used for control of Claviceps purpurea, in which the compositions comprising Fluopyram are applied to cereal plants.

### Plants

According to the invention all plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners, slips and seeds also belong to plant parts.

In one embodiment crop plants belonging to the plant family cereals are cereal plants.

In a preferred embodiment crop species, cultivars and varieties belonging to the cereal plants are rye, oats, barley triticale, wheat (spring wheat or winter wheat), hybrid wheat (spring wheat or winter wheat), and durum. In another embodiment plants to be treated for reduction of ergot and reduction of Claviceps purpurea are parental lines or inbred line of hybrid spring wheat, triticale, or hybrid winter wheat.

In one aspect wheat plants or plant parts are hybrid wheat plants or plant parts. In another aspect spring wheat plants or plant parts are spring wheat hybrid plants or plant parts. In another aspect winter wheat plants or plant parts are winter hybrid plants or plant parts.

### DETAILED DESCRIPTION OF THE PREFERRED EMBODIMENTS

The term “growth stage” refers to the growth stages as defined by the BBCH Codes in “Growth stages of mono- and dicotyledonous plants”, 2nd edition 2001, edited by Uwe Meier from the Federal Biological Research Centre for Agriculture and Forestry. The BBCH codes are a well-established system for a uniform coding of phonologically similar growth stages of all mono- and dicotyledonous plant species. The abbreviation BBCH derives from “Biologische Bundesanstalt, Bundessortenamt and Chemische Industrie”.

Some of these BBCH growth stages and BBCH codes for cereal plants are indicated in the following.

Growth stage 0: Germination
00 Dry seed (caryopsis)
01 Beginning of seed imbibition
03 Seed imbibition complete
05 Radicle emerged from caryopsis
06 Radicle elongated, root hairs and/or side roots visible
07 Coleoptile emerged from caryopsis
09 Emergence: coleoptile penetrates soil surface (cracking stage)
Growth stage 1: Leaf development1
10 First leaf through coleoptile
11 First leaf unfolded
12 2 leaves unfolded
13 3 leaves unfolded
1. Stages continuous till . . .
19 9 or more leaves unfolded
Growth stage 2: Tittering
20 No tillers
21 Beginning of tillering: first tiller detectable
22 2 tillers detectable
23 3 tillers detectable
2. Stages continuous till . . .
29 End of tillering. Maximum no. of tillers detectable
Growth stage 3: Stem elongation
30 Beginning of stem elongation: pseudostem and tillers erect,
first internode begins to elongate, top of inflorescence at least
1 cm above tillering node
31 First node at least 1 cm above tillering node
32 Node 2 at least 2 cm above node 1
33 Node 3 at least 2 cm above node 2
3. Stages continuous till . . .
37 Flag leaf just visible, still rolled
39 Flag leaf stage: flag leaf fully unrolled, ligule just visible
Principal growth stage 4: Booting
41 Early boot stage: flag leaf sheath extending
43 Mid boot stage: flag leaf sheath just visibly swollen
45 Late boot stage: flag leaf sheath swollen
47 Flag leaf sheath opening
49 First awns visible (in awned forms only)
Principal growth stage 5: Inflorescence emergence, heading
51 Beginning of heading: tip of inflorescence emerged from sheath,
first spikelet just visible
52 20% of inflorescence emerged
53 30% of inflorescence emerged
54 40% of inflorescence emerged
55 Middle of heading: half of inflorescence emerged
56 60% of inflorescence emerged
57 70% of inflorescence emerged
58 80% of inflorescence emerged
59 End of heading: inflorescence fully emerged . . .
Principal growth stage 6: Flowering, anthesis
61 Beginning of flowering: first anthers visible
65 Full flowering: 50% of anthers mature
69 End of flowering: all spikelets have completed flowering but
some dehydrated anthers may remain
Principal growth stage 7: Development of fruit
71 Watery ripe: first grains have reached half their final size
73 Early milk
75 Medium milk: grain content milky, grains reached final size, still green
77 Late milk
Principal growth stage 8: Ripening
83 Early dough
85 Soft dough: grain content soft but dry. Fingernail impression not held
87 Hard dough: grain content solid. Fingernail impression held
89 Fully ripe: grain hard, difficult to divide with thumbnail
Principal growth stage 9: Senescence
92 Over-ripe: grain very hard, cannot be dented by thumbnail
93 Grains loosening in day-time
97 Plant dead and collapsing
99 Harvested product

Particular preference is given in accordance with the invention to treating plants of the plant cultivars which are each commercially available or in use. Plant cultivars are understood to mean plants which have new properties (“traits”) and which have been obtained by conventional breeding, by mutagenesis or with the aid of recombinant DNA techniques. Crop plants may accordingly be plants which can be obtained by conventional breeding and optimization methods or by biotechnology and genetic engineering methods or combinations of these methods, including the transgenic plants and including the plant varieties which can and cannot be protected by plant variety rights.

The method according to the invention can thus also be used for the treatment of genetically modified organisms (GMOs), for example plants or seeds. Genetically modified plants (or transgenic plants) are plants in which a heterologous gene has been integrated stably into the genome. The term “heterologous gene” means essentially a gene which is provided or assembled outside the plant and which, on introduction into the cell nucleus genome, imparts new or improved agronomic or other properties to the chloroplast genome or the mitochondrial genome of the transformed plant by virtue of it expressing a protein or polypeptide of interest or by virtue of another gene which is present in the plant, or other genes which are present in the plant, being downregulated or silenced (for example by means of antisense technology, co-suppression technology or RNAi technology [RNA interference]). A heterologous gene present in the genome is likewise referred to as a transgene. A transgene which is defined by its specific presence in the plant genome is referred to as a transformation or transgenic event.

Plants and plant cultivars which are preferably treated according to the invention include all plants which have genetic material which imparts particularly advantageous, useful traits to these plants (whether obtained by breeding and/or biotechnological means). These plants may have been modified by mutagenesis or genetic engineering to provide a new trait to a plant or to modify an already present trait. Mutagenesis includes techniques of random mutagenesis using X-rays or mutagenic chemicals, but also techniques of targeted mutagenesis, to create mutations at a specific locus of a plant genome. Targeted mutagenesis techniques frequently use oligonucleotides or proteins like CRISPR/Cas, zinc-finger nucleases, TALENs or mega-nucleases to achieve the targeting effect. Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include herbicide tolerance, insect resistance, increased yield and tolerance to abiotic conditions, like drought. Herbicide tolerance has been created by using mutagenesis as well as using genetic engineering.

Plants and plant cultivars which may also be treated according to the invention are those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients or shade avoidance.

Plants and plant cultivars which may also be treated according to the invention are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to early flowering, flowering control for hybrid seed production, seedling vigour, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants that may also be treated according to the invention are hybrid plants that already express the characteristic of heterosis or hybrid vigour which generally results in higher yield, vigour, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in maize) be produced by detasseling, i.e. the mechanical removal of the male reproductive organs (or male flowers), but, more typically, male sterility is the result of genetic determinants in the plant genome. In that case, and especially when seed is the desired product to be harvested from the hybrid plants, it is typically useful to ensure that male fertility in hybrid plants that contain the genetic determinants responsible for the male sterility is fully restored. This can be accomplished by ensuring that the male parents have appropriate fertility restorer genes which are capable of restoring the male fertility in hybrid plants that contain the genetic determinants responsible for male sterility. Genetic determinants for male sterility may be located in the cytoplasm. Examples of cytoplasmatic male sterility (CMS) were for instance described in Brassica species (WO 1992/005251, WO 1995/009910, WO 1998/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396, in which, for example, a ribonuclease such as barnase is selectively expressed in the tapetum cells in the stamens. Fertility can then be restored by expression in the tapetum cells of a ribonuclease inhibitor such as barstar (e.g. WO 1991/002069).

Plants or plant cultivars (obtained by plant biotechnology methods such as genetic engineering) which may likewise be treated according to the invention are herbicide-tolerant plants, i.e. plants made tolerant to one or more given herbicides. Such plants can be obtained either by genetic transformation, or by selection of plants containing a mutation imparting such herbicide tolerance. Herbicide tolerance has been created via the use of transgenes to glyphosate, glufosinate, 2,4-D, dicamba, oxynil herbicides, like bromoxynil and ioxynil, sulfonylurea herbicides, ALS inhibitors and 4-hydroxyphenylpyruvate dioxygenase (HPPD) inhibitors, like isoxaflutole and mesotrione. Transgenes which have been used to provide herbicide tolerance traits comprise: for tolerance to glyphosate: cp4 epsps, epsps grg23ace5, mepsps, 2mepsps, gat4601, gat4621, goxv247; for tolerance to glufosinate: pat and bar, for tolerance to 2,4-D: aad-1, aad-12; for tolerance to dicamba: dmo; for tolerance to oxynil herbicies: bxn; for tolerance to sulfonylurea herbicides: zm-hra, csr1-2, gm-hra, S4-HrA; for tolerance to ALS inhibitors: csr1-2; and for tolerance to HPPD inhibitors: hppdPF, W336, avhppd-03. Herbicide-tolerant plants are for example glyphosate-tolerant plants, i.e. plants made tolerant to the herbicide glyphosate or salts thereof. For example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. Nos. 5,776,760 and 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the above-mentioned genes as described, for example, in WO 2001/024615 or WO 2003/013226.

Other herbicide-resistant plants are for example plants that have been made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One such efficient detoxifying enzyme is, for example, an enzyme encoding a phosphinothricin acetyltransferase (such as the bar or pat protein from Streptomyces species). Plants expressing an exogenous phosphinothricin acetyltransferase are for example described in U.S. Pat. Nos. 5,561,236; 5,648,477; 5,646,024; 5,273,894; 5,637,489; 5,276,268; 5,739,082; 5,908,810 and 7,112,665.

Further herbicide-tolerant plants are also plants that have been made tolerant to the herbicides inhibiting the enzyme hydroxyphenylpyruvatedioxygenase (HPPD). Hydroxyphenylpyruvatedioxygenases are enzymes that catalyse the reaction in which para-hydroxyphenylpyruvate (HPP) is transformed into homogentisate. Plants tolerant to HPPD-inhibitors can be transformed with a gene encoding a naturally occurring resistant HPPD enzyme, or a gene encoding a mutated HPPD enzyme according to WO 1996/038567, WO 1999/024585 and WO 1999/024586. Tolerance to HPPD inhibitors can also be obtained by transforming plants with genes encoding certain enzymes enabling the formation of homogentisate despite the inhibition of the native HPPD enzyme by the HPPD inhibitor. Such plants and genes are described in WO 1999/034008 and WO 2002/36787. Tolerance of plants to HPPD inhibitors can also be improved by transforming plants with a gene encoding an enzyme prephenate dehydrogenase in addition to a gene encoding an HPPD-tolerant enzyme, as described in WO 2004/024928.

Further herbicide-resistant plants are plants that have been made tolerant to acetolactate synthase (ALS) inhibitors. Known ALS-inhibitors include, for example, sulphonylurea, imidazolinone, triazolopyrimidines, pyrimidinyloxy(thio)benzoates, and/or sulphonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also in U.S. Pat. Nos. 5,605,011, 5,378,824, 5,141,870 and 5,013,659. The production of sulphonylurea-tolerant plants and imidazolinone-tolerant plants is described in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 1996/033270. Other imidazolinone-tolerant plants are also described in for example WO 2004/040012, WO 2004/106529, WO 2005/020673, WO 2005/093093, WO 2006/007373, WO 2006/015376, WO 2006/024351 and WO 2006/060634. Further sulphonylurea- and imidazolinone-tolerant plants are also described in for example WO 2007/024782.

Other plants tolerant to imidazolinone and/or sulphonylurea can be obtained by induced mutagenesis, selection in cell cultures in the presence of the herbicide or by mutation breeding as described for example for soya beans in U.S. Pat. No. 5,084,082, for rice in WO 1997/41218, for sugar beet in U.S. Pat. No. 5,773,702 and WO 1999/057965, for lettuce in U.S. Pat. No. 5,198,599 or for sunflower in WO 2001/065922.

Plants or plant cultivars (obtained by plant biotechnology methods such as genetic engineering) which may also be treated according to the invention are tolerant to abiotic stress factors. Such plants can be obtained by genetic transformation, or by selection of plants containing a mutation imparting such stress resistance. Particularly useful stress-tolerant plants include:
a. plants which contain a transgene capable of reducing the expression and/or the activity of the poly(ADP-ribose)polymerase (PARP) gene in the plant cells or plants as described in WO 2000/004173 or EP 04077984.5 or EP 06009836.5;
b. plants which contain a stress tolerance-enhancing transgene capable of reducing the expression and/or the activity of the PARG encoding genes of the plants or plant cells as described, for example, in WO 2004/090140;
c. plants which contain a stress tolerance-enhancing transgene coding for a plant-functional enzyme of the nicotinamide adenine dinucleotide salvage biosynthesis pathway, including nicotinamidase, nicotinate phosphoribosyltransferase, nicotinic acid mononucleotide adenyltransferase, nicotinamide adenine dinucleotide synthetase or nicotinamide phosphoribosyltransferase as described, for example, in EP 04077624.7 or WO 2006/133827 or PCT/EP07/002433.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase).

### Foliar Application

The foliar treatment of plants has been known for a long time and is the subject of constant improvements. Nevertheless, the treatment of plants gives rise to a series of problems which cannot always be solved in a satisfactory manner. For instance, it is desirable to develop methods for protecting the plant, the developing inflorescence and seed. It is additionally desirable to optimize the amount of Fluopyram used in such a way as to provide the best possible protection for the plant, in particular the developing inflorescence from attack by Claviceps purpurea, but without damaging the cereals plant itself by the active ingredient used.

In another embodiment a method for treating plants to control Claviceps purpurea in cereal plants at BBCH stage 50 or later by treating the cereal plant at BBCH stage 50 with Fluopyram.

In another embodiment a method for treating plants to control Claviceps purpurea in cereal plants between BBCH stage 50 and 80 by treating the cereal plant at BBCH stage 50 with Fluopyram.

In another embodiment a method for treating plants to reduce sclerotia of Claviceps purpurea in cereal plants at BBCH stage 90 or later by treating the cereal plant at BBCH stage 50 with Fluopyram.

In another embodiment a method for treating plants to reduce sclerotia of Claviceps purpurea in cereal plants at BBCH stage 90 or later by treating the cereal plant between BBCH stage 50 and 80 with Fluopyram.

In another embodiment a method for treating plants to control Claviceps purpurea in spring wheat, winter wheat, durum, hybrid spring wheat, hybrid winter wheat plants at BBCH stage 50 or later by treating the cereal plant at BBCH stage 50 with Fluopyram.

In another embodiment a method for treating plants to control Claviceps purpurea in spring wheat, winter wheat, durum, hybrid spring wheat, hybrid winter wheat plants between BBCH stage 50 and 80 by treating the cereal plant at BBCH stage 50 with Fluopyram.

In another embodiment a method for treating plants to reduce sclerotia of Claviceps purpurea in spring wheat, winter wheat, durum, hybrid spring wheat, hybrid winter wheat plants at BBCH stage 90 or later by treating the cereal plant at BBCH stage 50 with Fluopyram.

In another embodiment a method for treating plants to reduce sclerotia of Claviceps purpurea in spring wheat, winter wheat, durum, hybrid spring wheat, hybrid winter wheat plants at BBCH stage 90 or later by treating the cereal plant between BBCH stage 50 and 80 with Fluopyram.

In another embodiment a method for treating plants to control Claviceps purpurea in spring wheat plants at BBCH stage 50 or later by treating the cereal plant at BBCH stage 50 with Fluopyram.

In another embodiment a method for treating plants to control Claviceps purpurea in spring wheat plants between BBCH stage 50 and 80 by treating the cereal plant at BBCH stage 50 with Fluopyram.

In another embodiment a method for treating plants to reduce sclerotia of Claviceps purpurea in spring wheat plants at BBCH stage 90 or later by treating the cereal plant at BBCH stage 50 with Fluopyram.

In another embodiment a method for treating plants to reduce sclerotia of Claviceps purpurea in spring wheat plants at BBCH stage 90 or later by treating the cereal plant between BBCH stage 50 and 80 with Fluopyram.

In another embodiment a method for treating plants to control Claviceps purpurea in hybrid spring wheat plants at BBCH stage 50 or later by treating the cereal plant at BBCH stage 50 with Fluopyram.

In another embodiment a method for treating plants to control Claviceps purpurea in hybrid spring wheat plants between BBCH stage 50 and 80 by treating the cereal plant at BBCH stage 50 with Fluopyram.

In another embodiment a method for treating plants to reduce sclerotia of Claviceps purpurea in hybrid spring wheat plants at BBCH stage 90 or later by treating the cereal plant at BBCH stage 50 with Fluopyram.

In another embodiment a method for treating plants to reduce sclerotia of Claviceps purpurea in hybrid spring wheat plants at BBCH stage 90 or later by treating the cereal plant between BBCH stage 50 and 80 with Fluopyram.

In another embodiment a method for treating plants to control Claviceps purpurea in winter wheat plants at BBCH stage 50 or later by treating the cereal plant at BBCH stage 50 with Fluopyram.

In another embodiment a method for treating plants to control Claviceps purpurea in winter wheat plants between BBCH stage 50 and 80 by treating the cereal plant at BBCH stage 50 with Fluopyram.

In another embodiment a method for treating plants to reduce sclerotia of Claviceps purpurea in winter wheat plants at BBCH stage 90 or later by treating the cereal plant at BBCH stage 50 with Fluopyram.

In another embodiment a method for treating plants to reduce sclerotia of Claviceps purpurea in winter wheat plants at BBCH stage 90 or later by treating the cereal plant between BBCH stage 50 and 80 with Fluopyram.

In another embodiment a method for treating plants to control Claviceps purpurea in hybrid winter wheat plants at BBCH stage 50 or later by treating the cereal plant at BBCH stage 50 with Fluopyram.

In another embodiment a method for treating plants to control Claviceps purpurea in hybrid winter wheat plants between BBCH stage 50 and 80 by treating the cereal plant at BBCH stage 50 with Fluopyram.

In another embodiment a method for treating plants to reduce sclerotia of Claviceps purpurea in hybrid winter wheat plants at BBCH stage 90 or later by treating the cereal plant at BBCH stage 50 with Fluopyram.

In another embodiment a method for treating plants to reduce sclerotia of Claviceps purpurea in hybrid winter wheat plants at BBCH stage 90 or later by treating the cereal plant between BBCH stage 50 and 80 with Fluopyram.

In another embodiment a method for treating plants to control Claviceps purpurea in durum plants at BBCH stage 50 or later by treating the cereal plant at BBCH stage 50 with Fluopyram.

In another embodiment a method for treating plants to control Claviceps purpurea in durum plants between BBCH stage 50 and 80 by treating the cereal plant at BBCH stage 50 with Fluopyram.

In another embodiment a method for treating plants to reduce sclerotia of Claviceps purpurea in durum plants at BBCH stage 90 or later by treating the cereal plant at BBCH stage 50 with Fluopyram.

In another embodiment a method for treating plants to reduce sclerotia of Claviceps purpurea in durum at BBCH stage 90 or later by treating the cereal plant between BBCH stage 50 and 80 with Fluopyram.

One of the advantages of the present invention is that, owing to the particular systemic properties of Fluopyram, the treatment of the cereal plant during flowering with Fluopyram, enables not only the control of Claviceps purpurea on the plant itself, but also on the developing seeds resulting in a reduction of sclerotia in the harvested grain.

In another embodiment Fluopyram may be present in commercially available formulations and in the use forms, prepared from these formulations, as a mixture with one or more active ingredients selected from the group of Prothioconazole, Tebuconazole, Epoxiconazole, Difenoconazole, Fluquinconazole, Fluxapyroxad, Flutriafol, Azoxystrobin, Trifloxystrobin, Fluoxastrobin, Fludioxonil, Ipfentrifluconazole, Isoflucypam, Metalaxyl, Mefenoxam, Mefentrifluconazole, Pyraclostrobin, Pyrimethanil, Pydiflumetofen, Chlorothalonil, Spiroxamine, Bixafen, Penflufen, Fluxapyroxad, Boscalid, Benzovindiflupyr, Sedaxane, Isopyrazam, Metrafenone, Broflanilide, Imidacloprid, Clothianidin, Thiacloprid, Thiamethoxam, Rynaxapyr, Cyazypyr, Spirotetramate, Spiromesifen, Tetraniliprole, Flubendiamide, Cyclaniliprole, lambda-Cyhalothrin.

Particularly preferred are Prothioconazole, Isoflucypam, Fluxapyroxad, Fluxapyroxad, Pydiflumetofen, Mefentrifluconazole, Ipfentrifluconazole and Tebuconazole.

Most preferred are Prothioconazole and Tebuconazole.

The use of Fluopyram, Prothioconazole and Tebuconazole together is effected preferably with a dosage between 0.01 and 3 kg of Fluopyram/ha, between 0.01 and 3 kg of Prothioconazole/ha, between 0.01 and 3 kg of Tebuconazole/ha; more preferably between 0.025 and 1 kg of Fluopyram/ha, between 0.025 and 1 kg of Prothioconazole/ha, between 0.025 and 1 kg of Tebuconazole/ha; more preferably between 0.025 and 400 g of Fluopyram/ha, between 0.025 and 400 g of Prothioconazole/ha, between 0.025 and 400 g of Tebuconazole/ha. Even more preferred is a rate between 50 and 200 g of Fluopyram/ha, between 50 and 150 g of Prothioconazole/ha, between 50 and 150 g of Tebuconazole/ha. Mostly preferred are rates of 60, 75, 90 and 120 g of Fluopyram/ha, 75 or 150 g of Prothioconazole/ha, 75 g or 150 g of Tebuconazole/ha.

In another embodiment Fluopyram may be present in commercially available formulations and in the use forms, prepared from these formulations, as a mixture with one or more active ingredients selected from the group of safener comprising cloquintocet-mexyl, mefenpyr-diethyl, benoxacor, dichlormid, isoxadifen-ethyl, cyprosulfamide, fenclorim, fenchlorazole-ethyl, fluxofenim, naphthalic anhydride, cyometrinil, oxabetrinil, flurazole, furilazole, daimuron, cumyluron, dimepiperate, and dietholate.

Particularly preferred are cloquintocet-mexyl, mefenpyr-diethyl, isoxadifen-ethyl, cyprosulfamide. Most preferred are mefenpyr-diethyl.

The example which follows serves to illustrate the invention, but without restricting it.

### Example 1

In Canada, in 2017, a test plot was conducted with the spring wheat variety CTC Utmost. Fluopyram as well as market standards were applied according to table 1 on July 7^{th} between BBCH stage59 and 61 (. Assessment of sclerotia was done in fall 2017 96 days post application.

TABLE 1
Efficacy of fluopyram against Claviceps purpurea and reduction of sclerotia in wheat

| | | | Active | AI | | | | Number of |
|---|---|---|---|---|---|---|---|---|
| | | Formulation | Ingredient | Conc. | | Dose | Dose | Ergot bodies |
| Entry | Description | Type | conc | [Unit] | Dose | Unit | Concentration | per kg seed |
| 1 | UNTREATED | | | | | | | 16 |
| 2 | PROLINE | EC | 250 | g/l | 0.8 | L/HA | 200 g/ha | 12 |
| | (250 g/l | | | | | | | |
| | Prothioconazole) | | | | | | | |
| 3 | Fluopyram | EC | 150 | g/l | 1.333 | L/HA | 200 g/ha | 5 |
| 4 | PROPULSE | SE | 250 | g/l | 1 | L/HA | 125 g/ha | 3 |
| | (125 g/l) | | | | | | Fluopyram | |
| | Fluopyram | | | | | | and 125 g/ha | |
| | and 125 g/l | | | | | | Prothioconazole | |
| | Prothioconazole | | | | | | | |

TABLE 2
Yield of spring wheat treated with fluopyram against Claviceps purpurea

| | | | | | | | | | % yield |
|---|---|---|---|---|---|---|---|---|---|
| | | | Active | AI | | | | | compared |
| | | Formuation | Ingredient | Conc. | | Dose | Dose | Appl. | to |
| Entry | Description | Type | conc | [Unit] | Dose | Unit | Concentration | Code | Untreated |
| 1 | UNTREATED | | | | | | | | 100 |
| 2 | PROLINE | EC | 250 | g/l | 0.8 | L/HA | 200 g/ha | A | 110.25 |
| | (250 g/l | | | | | | | | |
| | Prothioconazole) | | | | | | | | |
| 3 | Fluopyram | EC | 150 | g/l | 1.333 | L/HA | 200 g/ha | A | 109.85 |
| 4 | PROPULSE | SE | 250 | g/l | 1 | L/HA | 125 g/ha | A | 110.35 |
| | (125 g/l) | | | | | | Fluopyram | | |
| | Fluopyram | | | | | | and 125 g/ha | | |
| | and 125 g/l | | | | | | Prothioconazole | | |
| | Prothioconazole | | | | | | | | |

### Example 2

In Canada, in 2018, 3 test plots were conducted on spring wheat (1 trial—AC Goodeve) and durum wheat (2 trials on AC Strongfield). Fluopyram as well as market standards were applied according to table 3 between Jul. 6-9, 2018 between BBCH stage 61-63 (early flowering). Assessment of sclerotia was conducted in fall 2018 on harvested grain samples.

PROPULSE represents an SE formulation of 125 g/l Fluopyram and 125 g/l Prothioconazole.

TABLE 3
Efficacy of fluopyram against Claviceps purpurea and reduction of sclerotia in wheat

| | | | Trial No 1 | Trial No 2 | Trial No 3 |
|---|---|---|---|---|---|
| | | | number of | number of | number of |
| | | | Ergot | Ergot | Ergot |
| | | Dose Concentration | bodies per | bodies per | bodies per |
| Entry | Description | [g/ha] | kg seed | kg seed | kg seed |
| 1 | UNTREATED | n/a | 0.5 | 2.3 | 1.3 |
| 2 | 380 SC | 60 g/ha (Fluopyram) + 75 | 0.5 | 0.3 | 0 |
| | CoFormulation | g/ha (Tebuconazole) + 150 | | | |
| | | g/ha (Prothioconazole) as | | | |
| | | a Suspension Concentrate | | | |
| | | Co-Formulation | | | |
| 3 | 380 | 60 g/ha (Fluopyram) + 75 | 0 | 0.3 | 0.3 |
| | TM Equivalent | g/ha (Tebuconazole) + 150 | | | |
| | | g/ha (Prothioconazole) | | | |
| | | delivered as a Tank | | | |
| | | Mixture | | | |
| 4 | Fluopyram + | 75 g/ha (Fluopyram) + 75 | 0 | 0.7 | 0 |
| | Tebuconazole + | g/ha (Tebuconazole) + 150 | | | |
| | Prothionazole | g/ha (Prothioconazole) | | | |
| 5 | Fluopyram + | 90 g/ha (Fluopyram) + 75 | 0 | 1 | 0 |
| | Tebuconazole + | g/ha (Tebuconazole) + 150 | | | |
| | Prothionazole | g/ha (Prothioconazole) | | | |
| 6 | Tebuconazole + | 75 g/ha (Tebuconazole) + | 0.8 | 0.7 | 0 |
| | Prothionazole | 150 g/ha | | | |
| | | (Prothioconazole) | | | |
| 7 | Fluopyram 500 SC | 60 g/ha | 0 | 2 | 0.3 |
| 8 | Fluopyram 500 SC | 75 g/ha | 0.3 | 1 | 0.3 |
| 9 | Fluopyram 500 SC | 90 g/ha | 0.8 | 1.3 | 0 |
| 10 | Fluopyram 500 SC | 120 g/ha | 0 | 3 | 1.3 |
| 11 | PROPUESE (125 g/l) | 125 g/ha Fluopyram and | 0 | 1 | 0 |
| | Fluopyram and 125 | 125 g/ha Prothioconazole | | | |
| | g/l Prothioconazole) | | | | |

1. A method of controlling Claviceps purpurea and/or reducing sclerotia of Claviceps purpurea in cereal plants, the method comprising treating a cereal plant with succinate dehydrogenase inhibitor Fluopyram.

2. The method according to claim 1, wherein the Fluopyram is applied as a foliar treatment to the cereal plant.

3. The method according to claim 1, wherein the Fluopyram is applied as a foliar treatment to the cereal plant on or after a BBCH 50.

4. The method according to claim 1, wherein the Fluopyram is applied as a foliar treatment at a rate of 50 g to 300 g per hectare.

5. The method according to claim 1, wherein the cereal plant is wheat.

6. The method according to claim 1, wherein the cereal plant is hybrid wheat.

7. The method according to claim 1, wherein the Fluopyram is used in combination with a further active fungicidal ingredient.

8. The method according to claim 1, Fluopyram is used in combination with Prothioconazole or Tebuconazole, or Prothioconazole and Tebuconazole.

9. A fungicidal composition comprising Fluopyram, Prothioconazole and Tebuconazole, wherein the Fluopyram resulting in an application rate of 70 g/ha to 80 g/ha, the Prothioconazole resulting an application rate of 140 g/ha to 160 g/ha and the Tebuconazole resulting an application rate of 70 g/ha to 80 g/ha.
